(19) United States
(12) Patent Application Publication
(10) Pub. No.: US 2013/0125695 A1
(43) Pub. Date: May 23, 2013

(54) GEAR TRANSMISSION DEVICE AND ROBOT ARM USING THE SAME

(71) Applicant: BO LONG, Shenzhen City (CN)

(72) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/427,919

(22) Filed: Mar. 23, 2012

(30) Foreign Application Priority Data
Nov. 22, 2011 (CN) 201110373095.8

(51) Int. Cl. B25J 17/00; F16H 35/06

(52) U.S. Cl. 74/490.05; 74/397; 901/28

(57) ABSTRACT

A gear transmission device includes a transmission mechanism, and a gear backlash adjusting mechanism engaged with the transmission mechanism. The transmission mechanism includes a first adjusting gear and a second adjusting gear meshing together. The adjusting mechanism includes a fixing plate and an adjusting member sleeved on the first adjusting gear. The fixing plate defines a limiting hole. The adjusting member comprises a flange received in the limiting hole. A maximum distance from an edge of the flange near the second adjusting gear to the rotation shaft of the first adjusting gear is greater than a minimum distance from an end of the flange away from the second adjusting gear to the rotation shaft of the first adjusting gear.

### BACKGROUND

1. Technical Field

The present disclosure relates to gear transmission devices, particularly to a gear transmission device, and a robot arm using the gear transmission device.

2. Description of Related Art

An industrial robot arm may include transmission gears. In order to ensure sufficient lubrication between gears and prevent the gears from being jammed due to a high working temperature, some amount of backlash is designed into the meshed gears. The amount of backlash in the gear transmission device may increase after working for a period of time, and the life and precision of the gear transmission mechanism may deteriorate as a result, because of aggravated abrasion and oscillation caused by the deteriorated meshing condition.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of an embodiment of a robot arm.

FIG. 2 is a partial, isometric view of the robot arm of FIG. 1.

FIG. 3 is an enlarged, cross-sectional view of the robot arm of FIG. 1.

FIG. 4 is an enlarged, isometric view of a circled portion IV shown in FIG. 2.

FIG. 5 is an enlarged, right side view of the robot arm shown in FIG. 2.

### DETAILED DESCRIPTION

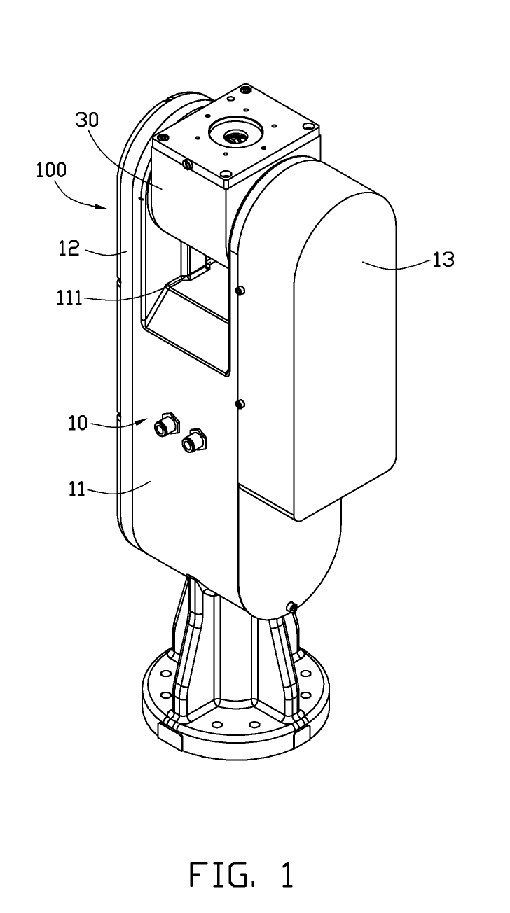

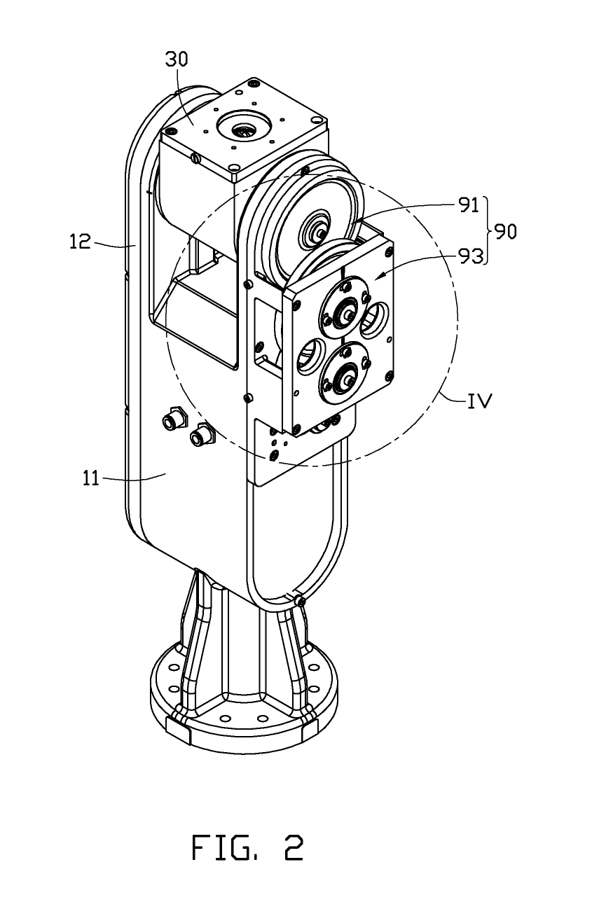

Referring to FIGS. 1 to 3, an embodiment of a robot arm 100 includes a first arm 10, a second arm 30, a pair of connecting assemblies 50, a driving mechanism 70, and a gear transmission device 90. The first arm 10 movably connects with the second arm 30 via the pair of connecting assemblies 50. The driving mechanism 70 is mounted on the first arm 10. The second arm 30 rotatably connects to the first arm 10 via the gear transmission device 90 and the driving mechanism 70, and the driving mechanism 70 drives the second arm 30 to rotate via the gear transmission device 90.

The first arm 10 includes a main body 11, a pair of extending portions 12, and a cover 13. The main body 11 is a substantially rectangular hollow structure. The pair of extending portions 12 extend from opposite edges of an end of the main body 11, and cooperatively define a substantially U-shaped groove 111 with the main body 11. Each of the pairs of extending portions 12 defines a mounting hole (not labeled) at the sidewall thereof communicating with the groove 111. The pair of connecting assemblies 50 are mounted in the corresponding mounting holes of the pair of extending portions 12 to connect with the second arm 30, such that the second arm 30 is received in the groove 111. The gear transmission device 90 is mounted on a sidewall of the first arm 10 adjacent to one of the pair of extending portions 12, and covered by the cover 15.

Each of the pair of connecting assemblies 50 includes a connecting member 51 and a bearing 53. The connecting member 51 includes a hollow cylindrical body 511, and a flange 513 extending outwards from the circumference of one end of the cylindrical body 511. The cylindrical body 511 passes through the corresponding mounting hole, and the flange 513 is fixed with the corresponding one of the pair of extending portions 12. The bearing 53 is sleeved on the corresponding cylindrical body 511. The second arm 30 is mounted on the bearings 53 at the opposite sidewalls, thereby movably connecting with the first arm 10.

The driving mechanism 70 includes a drive member 71 and a drive rod 73 fixed on the drive member 71. The drive member 71 is received in the main body 11 and fixed on the inner sidewall of the main body 11, and the drive rod 73 is exposed from the sidewall of the main body 11 below the gear transmission device 90, and covered by the cover 15. The drive rod 73 connects with the gear transmission device 90. The drive member 71 rotates the drive rod 73, and the drive rod 73 further drives the gear transmission device 90 to rotate. In the illustrated embodiment, the drive member 71 is a motor. The drive member 71 can be other prime movers, such as a hydraulic or pneumatic mechanism.

The gear transmission device 90 includes a transmission mechanism 91 and a gear backlash adjusting mechanism 93 engaged with the transmission mechanism 91. The transmission mechanism 91 is mounted on the sidewall of the first arm 10 adjacent to one of the pair of extending portions 12. The gear backlash adjusting mechanism 93 is mounted on the transmission mechanism 91. The transmission mechanism 91 connects with the drive rod 73 to be driven by the drive member 71, and then drives the second arm 30 to rotate. The gear backlash adjusting mechanism 93 is used to adjust the backlash of the meshed gears of the transmission mechanism 91 during normal working.

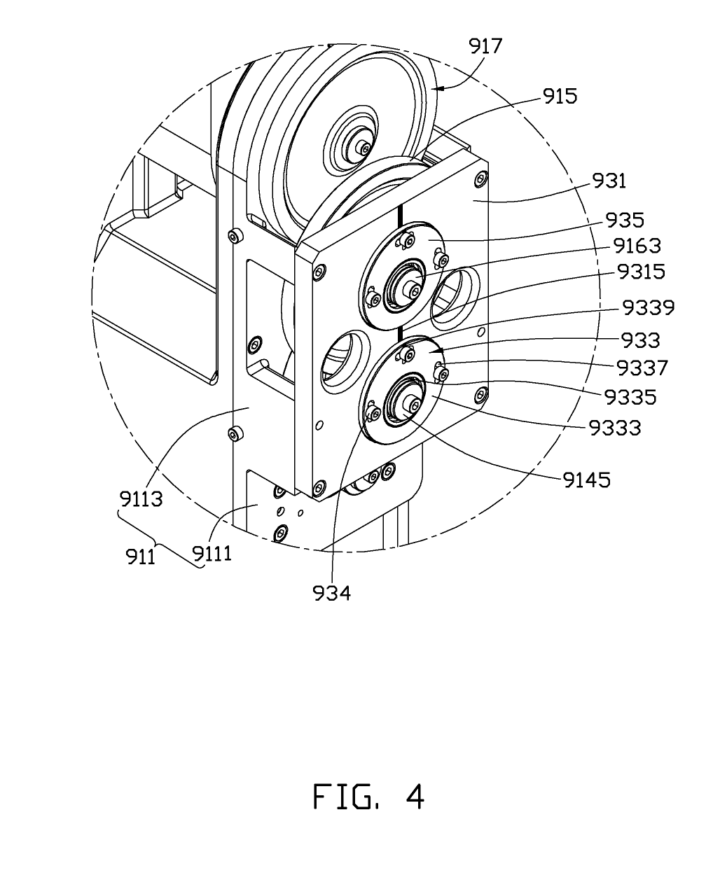

Referring to FIG. 4, the transmission mechanism 91 includes a mounting plate 911, a first gear 913, a first adjusting gear 914, a second gear 915, a second adjusting gear 916, a third gear 917, a bearing 918, and an output shaft 919. The mounting plate 911 includes a mounting portion 9111 and a protruding portion 9113. The mounting portion 9111 is fixed on the sidewall of the first arm 10, and defines a pair of through holes (not labeled) respectively aligned with the drive rod 73 and the second arm 30. The protruding portion 9113 perpendicularly protrudes from the opposite sides of the mounting portion 9111, for supporting the gear backlash adjusting mechanism 93. The drive rod 73 passes through the through hole of the mounting portion 9111. The first gear 913 is sleeved on the drive rod 73, to allow the drive rod 73 to drive the first gear 913 to rotate.

The first adjusting gear 914 is located beside the first gear 913, and includes a first gear portion 9141, a second gear portion 9143, and a first shaft portion 9145. The second gear portion 9143 extends from the first gear portion 9141 away from the mounting portion 9111, and the first shaft portion 9145 extends from the second gear portion 9143 away from the first gear portion 9141. The first gear portion 9141 meshes with the first gear 913.

The second gear 915 and the second adjusting gear 916 are located beside the first adjusting gear 914 away from the first gear 913, the second gear 915 is sleeved on the second adjusting gear 916. The second gear 915 meshes with the second gear portion 9143. The second adjusting gear 916 includes a gearing portion 9161 and a shaft portion 9163 perpendicularly extending from the gearing portion 9163 towards the gear backlash adjusting mechanism 93. The second gear 915 is sleeved on the shaft portion 9163. The third gear 917 is positioned beside the second adjusting gear 916 away from the second gear 915, and meshes with the gearing portion 9161.

The bearing 918 is mounted on the through hole of the mounting portion 9111 corresponding to the second arm 30. The output shaft 919 includes a base body 9191 and an end portion 9193 formed at the distal end of the base body 9191. The base body 9191 is located at the side of the mounting portion 9111 away from the protruding portion 9113, and is fixed with the second arm 30. The end portion 9193 passes through the corresponding through hole of the mounting portion 9111, and the bearing 918 is sleeved on the end portion 9193, to prevent the mounting plate 9111 rotating in following the output shaft 919. The third gear 917 is sleeved on the end portion 9193 to drive the output shaft 919 to rotate. In the illustrated embodiment, the first gear 913, the first adjusting gear 914, the second gear 915, the second adjusting gear 916, and the third gear 917 are spur gears. The first gear 913, the first adjusting gear 914, the second gear 915, the second adjusting gear 916, and the third gear 917 can be other types of gears, such as bevel gears.

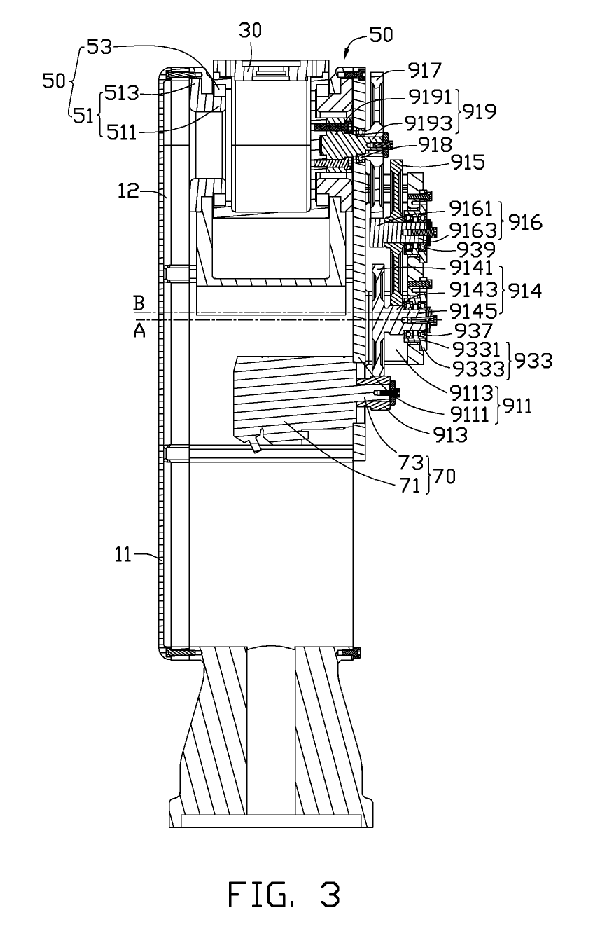

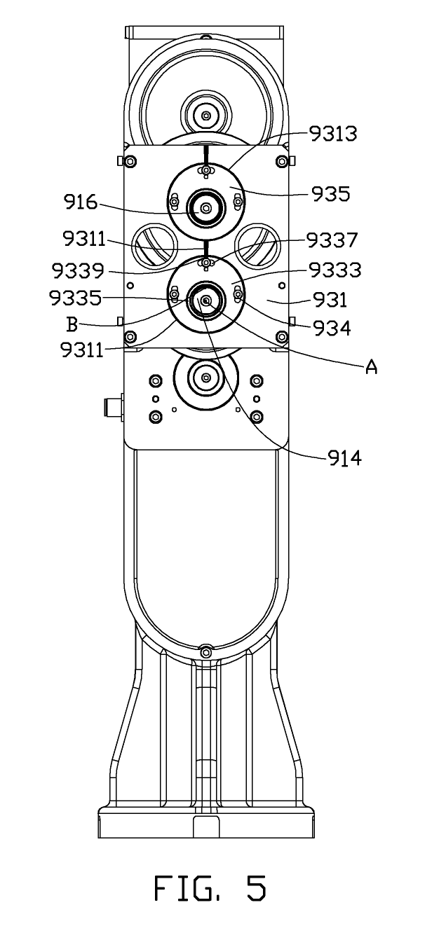

Referring to FIG. 5, the gear backlash adjusting mechanism 93 includes a fixing plate 931, a first adjusting member 933, a plurality of fixing members 934, a second adjusting member 935, a first bearing 937 (shown in FIG. 3), and a second bearing 939. The fixing plate 931 is fixed on the protruding portion 9113 parallel to the mounting portion 9111. The fixing plate 931 defines a first limiting hole 9311 corresponding to the position of the first adjusting gear 914, and a second limiting hole 9313 corresponding to the position of the second adjusting gear 916. The first shaft portion 9145 of the first adjusting gear 914 passes through the first limiting hole 9311, and the shaft portion 9163 of the second adjusting gear 916 passes through the second limiting hole 9313. The fixing plate 931 has a plurality of first scale marks 9315 between the first limiting hole 9311 and the second limiting hole 9313, and a continuation of the line of the plurality of scale marks 9315 would intersect with the axis of the first shaft portion 9145.

The first adjusting member 933 includes a cylindrical body 9331, and a flange 9333 extending outwards from the circumference of the cylindrical body 9331. The first adjusting member 933 defines a receiving hole 9335 through the cylindrical body 9331 and the flange 9333 along the axis. The first bearing 937 is sleeved on the first shaft portion 9145, and the cylindrical body 9331 is sleeved on the first bearing 937, to prevent the first adjusting member 933 rotating, following the rotation of the first adjusting gear 914. The rotation shaft of the first adjusting gear 914 is marked “A” in FIG. 5, and the rotation shaft of the flange 9333 is marked “B”.

The flange 9333 is substantially circular, and the circumference thereof corresponds to the shape of the first limiting hole 9311. The flange 9333 is received in the first limiting hole 9311. A maximum distance from an edge of the flange 9333 near the second adjusting gear 916 to the rotation shaft A of the first adjusting gear 914 is greater than a minimum distance from an end of the flange 9333 away from the second adjusting gear 916 to the rotation shaft of the first adjusting gear 914 (shown in FIG. 5). The flange 9333 defines a plurality of curved slots 9337 around the circumference, and is fixed with the fixing plate 931 via the plurality of fixing members 934 passing through the plurality of curved slots 9337. The flange 9333 forms a plurality of second scale marks 9339 adjacent to the plurality of first scale marks 9315, the plurality of second scale marks 9339 are aligned with the plurality of first scale marks 9315. The continuation of the line of the plurality of second scale marks 9339 intersects with the axis of the first shaft portion 9145. Each of the plurality of first scale marks 9315 and the plurality of second scale marks 9339 defines a certain quantity or degree.

The second adjusting member 935 is similar to the first adjusting member 933, and is sleeved on the shaft portion 9163 received in the second limiting hole 9313 via the second bearing 939. In the illustrated embodiment, the plurality of fixing members 934 are screws. There are two of the first bearings 937 and two of the second bearings 939.

In assembly, first, the second arm 30 is movably mounted on the first arm 10 via the pair of connecting assemblies 50. Second, mounting plate 911 is mounted on the sidewall of the first arm 10. The drive member 71 is mounted in the first arm 10, and the drive rod 73 is exposed from the through hole of the mounting portion 9111. Third, the first gear 913 is fixed to the drive rod 73, and the first gear 913, the first adjusting gear 914, the second gear 915, the second adjusting gear 916, and the third gear 917 are meshed together one by one. The output shaft 919 connects the third gear 917 with the second arm 30. Fourth, the fixing plate 931 is fixed to the protruding portion 9113, and the first adjusting member 933 and the second adjusting member 935 are sleeved on the corresponding shaft portions via the bearings. Finally, the cover 15 is put in place on the gear transmission device 90.

In use, the drive member 71 drives the second arm 30 to rotate via the first gear 913, the first adjusting gear 914, the second gear 915, the second adjusting gear 916, the third gear 917, and the output shaft 919. During use, the backlash between the first adjusting gear 914 and the second gear 915 increases. In order to reduce the backlash, the plurality of fixing members 934 must be detached and then the first adjusting member 933 rotated. Since the flange 9333 is received in the first limiting hole 9311, the first adjusting member 933 rotates around the rotation shaft B. The first adjusting member 933 drives the first adjusting gear 914 to rotate around the rotation shaft A.

In addition, the maximum distance from an edge of the flange 9333 near the second adjusting gear 916 to the rotation shaft A is greater than the minimum distance from an end of the flange 9333 away from the second adjusting gear 916 to the rotation shaft A, thus the rotation shaft A moves towards the second adjusting gear 916. That it is, the rotation shaft A rotates around the rotation shaft B, and the distance between the rotation shaft A and the rotation shaft of the second adjusting gear 916 is gradually decreased. Thus the backlash between the first adjusting gear 914 and the second gear 915 is decreased, putting the first adjusting gear 914 into a tighter mesh with the second gear 915. During the rotation of the first adjusting member 933, the plurality of first scale marks 9315 interleave with the second scale marks 9339, to indicate the degrees of rotation of the first adjusting member 933, thereby revealing, and allowing recordability of, the quantity or value necessary to control the backlash between the first adjusting gear 914 and the second gear 915. After adjusting, the flange 9333 is fixed with the fixing plate 931 by the plurality of fixing members 934. In the illustrated embodiment, the backlash between the first adjusting gear 914 and the second gear 915 is increased by rotating the second adjusting member 935.

If the rotation shaft of the second adjusting member 935 is located between rotation shaft of the second adjusting gear 916 and the rotation shaft of the first adjusting member 933, the backlash between the first adjusting gear 914 and the second gear 915 will be decreased by rotating the second adjusting member 935. The first adjusting gear 914 can be designed to mesh with the second adjusting gear directly, and the second gear 915 can be omitted. The rotation shaft of the first adjusting member 933, the rotation shaft of the first adjusting gear 914, and the rotation shaft of the second adjusting member 935 are not required to be in a straight line, but information as to the condition of the rotation shaft of the second adjusting gear located between the rotation shaft of the first adjusting member 933 and the rotation shaft of the second adjusting member 935 is needed, to ensure the first adjusting member 933 drive the rotation shaft of the first adjusting gear 914 to rotate correctly around the rotation shaft of the first adjusting member 933.

The driving mechanism 70 drives the second arm 30 to rotate via the transmission mechanism 91. The backlash between the first adjusting gear 914 and the second gear 915 is very easily adjusted just by rotating the first adjusting member 933, to re-establish a tight mesh between the first adjusting gear 914 and the second gear 915.

It is believed that the present embodiments and their advantages will be understood from the foregoing description, and various changes may be made thereto without departing from the spirit and scope of the embodiments or sacrificing all of its material advantages.

What is claimed is:

1. A gear transmission device, comprising:
a transmission mechanism comprising a first adjusting gear and a second adjusting gear meshing with the first adjusting gear;
a gear backlash adjusting mechanism engaged with the transmission mechanism, comprising a fixing plate and a first adjusting member sleeved on the first adjusting gear;
wherein the first adjusting gear drives the second adjusting gear to rotate; the fixing plate defines a first limiting hole; the first adjusting member comprises a flange, and the flange is received in the first limiting hole; a maximum distance from an edge of the flange near the second adjusting gear to a rotation shaft of the first adjusting gear is greater than a minimum distance from an end of the flange away from the second adjusting gear to the rotation shaft of the first adjusting gear; when rotate the first adjusting member, the first adjusting member is capable of driving the rotation shaft of the first adjusting gear to move towards a rotation shaft of the second adjusting gear.

2. The gear transmission device of claim 1, wherein the first adjusting member further comprises a cylindrical body; the flange extends outwards from a circumference of the cylindrical body; the first adjusting member defines a receiving hole through the cylindrical body and the flange along an axis of the receiving hole; the first adjusting gear passes through the receiving hole.

3. The gear transmission device of claim 2, wherein the gear backlash adjusting mechanism further comprises a plurality of fixing members; The flange defines a plurality of curved slots around a circumference of the flange; each of the plurality of fixing members passes through each of the plurality of curved slots to fix the flange with the fixing plate.

4. The gear transmission device of claim 2, wherein the fixing plate forms a plurality of first scale marks besides the first limiting hole, and a continuation of the line of the plurality of first scale marks intersects with an axis of a shaft portion of the first adjusting member; the flange define a plurality of second scale marks adjacent to the plurality of first scale marks, each of the plurality of second scale marks aligns with each of the plurality of first scale marks; a continuation of the line of the plurality of second scale marks intersects with the axis of the shaft portion of the first adjusting member; degrees of rotation of the first adjusting member are adjustable by an amount of the plurality of first scale marks interleaving the plurality of second scale marks.

5. The gear transmission device of claim 1, wherein the fixing plate further defines a second limiting hole corresponding a position of the second adjusting gear; the gear backlash adjusting mechanism further comprises a second adjusting member sleeved on the second adjusting gear, and received in the second limiting hole; a rotation shaft of the second adjusting gear and a rotation shaft of the second adjusting member are non coaxial.

6. The gear transmission device of claim 1, wherein the gear transmission device further comprises a first gear, a second gear, a third gear, and a output shaft; the first gear meshes with the first adjusting gear; the second gear is sleeved on the second adjusting gear, and meshes with the first adjusting gear; the third gear is sleeved on the output shaft, and meshes with the second adjusting gear; the first gear drives the output shaft to rotate via the first adjusting gear, the second gear, the second adjusting gear, and the third gear.

7. A robot arm, comprising:
a first arm,
a second arm movably connected to the first arm;
a gear transmission device mounted on a sidewall of the first arm, comprising a transmission mechanism, the transmission mechanism comprising a first adjusting gear and a second adjusting gear meshed with the first adjusting gear; and
a gear backlash adjusting mechanism engaged with the transmission mechanism, the gear backlash adjusting mechanism comprising a fixing plate fixed on the transmission mechanism, and a first adjusting member sleeved on the first adjusting gear; and
a driving mechanism mounted on the sidewall of the first arm, and driving the second arm to rotate via the transmission mechanism;
wherein the first adjusting gear connected to the driving mechanism; the first adjusting gear drives the second adjusting gear to rotate; the fixing plate defines a first limiting hole; the first adjusting member comprises a flange, and the flange is received in the first limiting hole; a maximum distance from an edge of the flange near the second adjusting gear to a rotation shaft of the first adjusting gear is greater than a minimum distance from an end of the flange away from the second adjusting gear to the rotation shaft of the first adjusting gear; when rotate the first adjusting member, the first adjusting member is capable of driving the rotation shaft of the first adjusting gear to move towards a rotation shaft of the second adjusting gear.

8. The robot arm of claim 7, wherein the first adjusting member further comprises a cylindrical body; the flange extends outwards from a circumference of the cylindrical body; the first adjusting member defines a receiving hole through the cylindrical body and the flange along an axis of the receiving hole; the first adjusting gear passes through the receiving hole.

9. The robot arm of claim 8, wherein the gear backlash adjusting mechanism further comprises a plurality of fixing members; the flange defines a plurality of curved slots around a circumference; each of the plurality of fixing members passes through each of the plurality of curved slots to fix the flange with the fixing plate.

10. The robot arm of claim 8, wherein the fixing plate forms a plurality of first scale marks besides the first limiting hole, and a continuation of the line of the plurality of first scale marks intersects with an axis of a shaft portion of the first adjusting member; the flange defines a plurality of second scale marks adjacent to the plurality of first scale marks, each of the plurality of second scale marks aligns with each of the plurality of first scale marks; a continuation of the line of the plurality of second scale marks intersects with the axis of the shaft portion of the first adjusting member; degrees of rotation of the first adjusting member are adjustable by an amount of the plurality of first scale marks interleaving the plurality of second scale marks.

11. The robot arm of claim 7, wherein the fixing plate further defines a second limiting hole corresponding a position of the second adjusting gear; the gear backlash adjusting mechanism further comprises a second adjusting member sleeved on the second adjusting gear, and received in the second limiting hole; a rotation shaft of second adjusting gear and a rotation shaft of the second adjusting member are non coaxial.

12. The robot arm of claim 7, wherein the first arm comprises a main body, a pair of extending portions, and a cover; the main body is a hollow shell, the pair of extending portions extend from the main body at an opposite side towards the second arm, and the pair of extending portions define a groove cooperate with the main body; the second arm is received in the groove; the cover is configured to cover the gear transmission device.

13. The robot arm of claim 12, wherein the robot arm further comprises a pair of connecting assemblies; the pair of connecting assemblies connect the second arm with the pair of extending portions.

14. The robot arm of claim 13, wherein each of the pair of connecting assemblies comprises a connecting member and a bearing; each of the pair of extending portions defines a mounting hole at a sidewall towards the groove; the connecting member is received on the mounting hole; the bearing is sleeved on the connecting member; the second arm is sleeve on the bearing at an opposite sidewall.

15. The robot arm of claim 12, wherein the driving mechanism comprises a drive member and a drive rod fixed on the drive rod; the drive member is received in the main body, and capable of driving the drive rod to rotate.

16. The robot arm of claim 15, wherein the gear transmission device further comprises a first gear, a second gear, a third gear, and a output shaft; the first gear is sleeved on the drive rod, and meshes with the first adjusting gear; the second gear is sleeved on the second adjusting gear, and meshes with the first adjusting gear; the third gear is sleeved on the output shaft, and meshes with the second adjusting gear; the output shaft is fixed to the second arm; the drive member drives the second arm to rotate via the first gear, the first adjusting gear, the second gear, the second adjusting gear, the third gear, and the output shaft.
